(19) United States
(12) Patent Application Publication
(10) Pub. No.: US 2009/0235566 A1
(43) Pub. Date: Sep. 24, 2009

(54) DISPLAY SYSTEM AND METHOD

(75) Inventor: William K. GRANT, Canton, GA (US)

Correspondence Address: GARDNER GROFF GREENWALD & VILLANUEVA. PC, 2018 POWERS FERRY ROAD, SUITE 800, ATLANTA, GA, 30339, US

(73) Assignee: GRANT DESIGN COLLABORATIVE, INC., Canton, GA (US)

(21) Appl. No.: 12/406,298

(22) Filed: Mar. 18, 2009

Related U.S. Application Data
(60) Provisional application No. 61/037,898, filed on Mar. 19, 2008.

(51) Int. Cl. G09F 13/00; G09F 15/00

(52) U.S. Cl. 40/541; 40/584

(57) ABSTRACT

A system and method of displaying an image, including an array of cylindrical or tubular members, optionally retained within one or more base and/or header structures, and having an image applied onto some or all of the cylindrical or tubular members. The cylindrical or tubular members, and/or the media onto which the image is applied can be entirely or partially transparent or translucent, so that the image is partially see-through.

### CROSS-REFERENCE TO RELATED APPLICATION

This application claims the benefit of U.S. Provisional Patent Application Ser. No. 61/037,898, filed Mar. 19, 2008, the entirety of which is hereby incorporated herein by reference for all purposes.

### TECHNICAL FIELD

The present invention relates generally to the field of display systems and methods, and more particularly to a system and method of displaying an image upon an array of tubular or cylindrical elements.

### BACKGROUND OF THE INVENTION

Various methods and systems are known for displaying images, for example in marketing displays. Continued improvement is sought in this field, to improve the display characteristics, and/or to increase attention and interest in the display. It is to the provision of an improved system and method of displaying images that the present invention is directed.

### SUMMARY OF THE INVENTION

In example embodiments, the present invention is an array of cylindrical or tubular elements, upon which one or more images are applied, projected or otherwise displayed for visual observation or other sensory recognition by a human or animal target audience.

In one aspect, the present invention comprises a footer or base, an array of generally elongate transparent or translucent cylindrical or tubular elements supported by the base, and optionally a header or cap. An image is displayed on the cylindrical or tubular elements. Optionally, the image is displayed thereon in the form of a transparent or translucent laminate or film onto which the image has been printed or otherwise applied.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

FIG. 1 is a first view of display systems according to the present invention.

FIG. 2 is a second view of display systems according to the present invention.

FIG. 3 is another view of a display system according to the present invention.

FIG. 4 is another view of a display system according to the present invention.

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

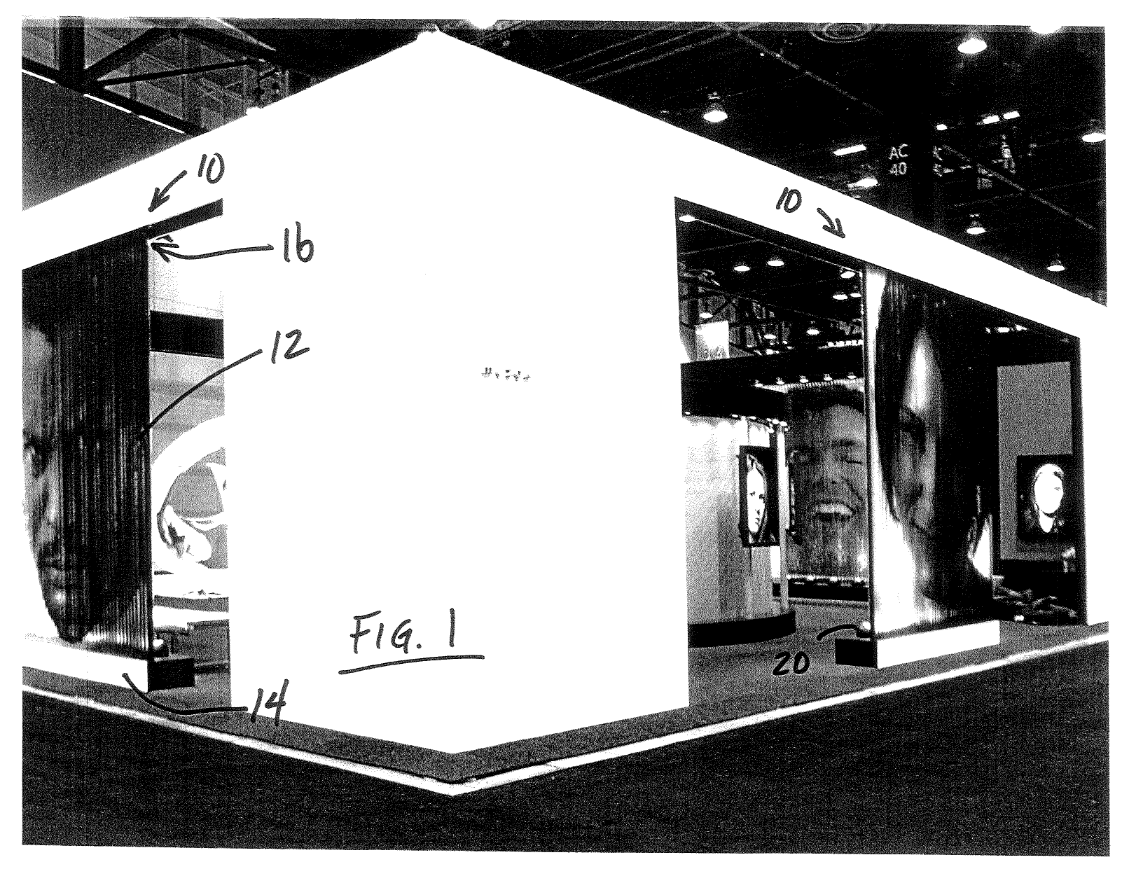

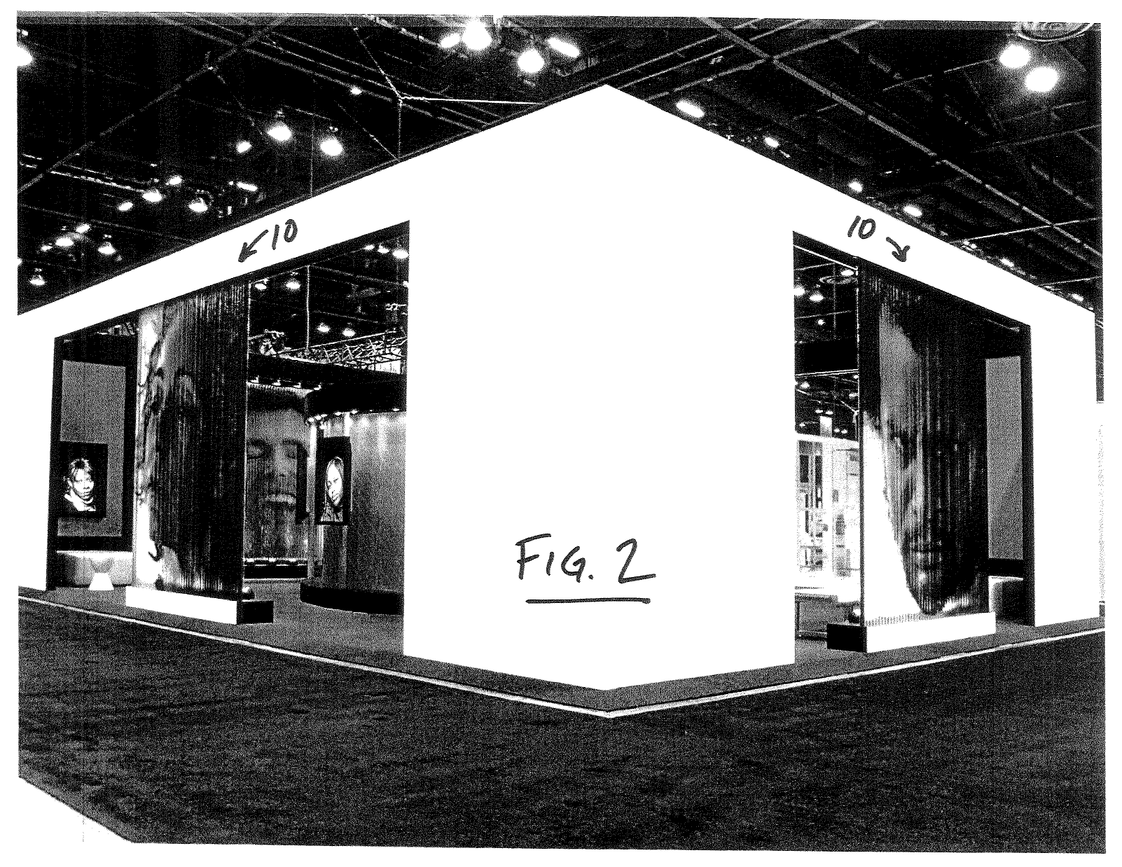

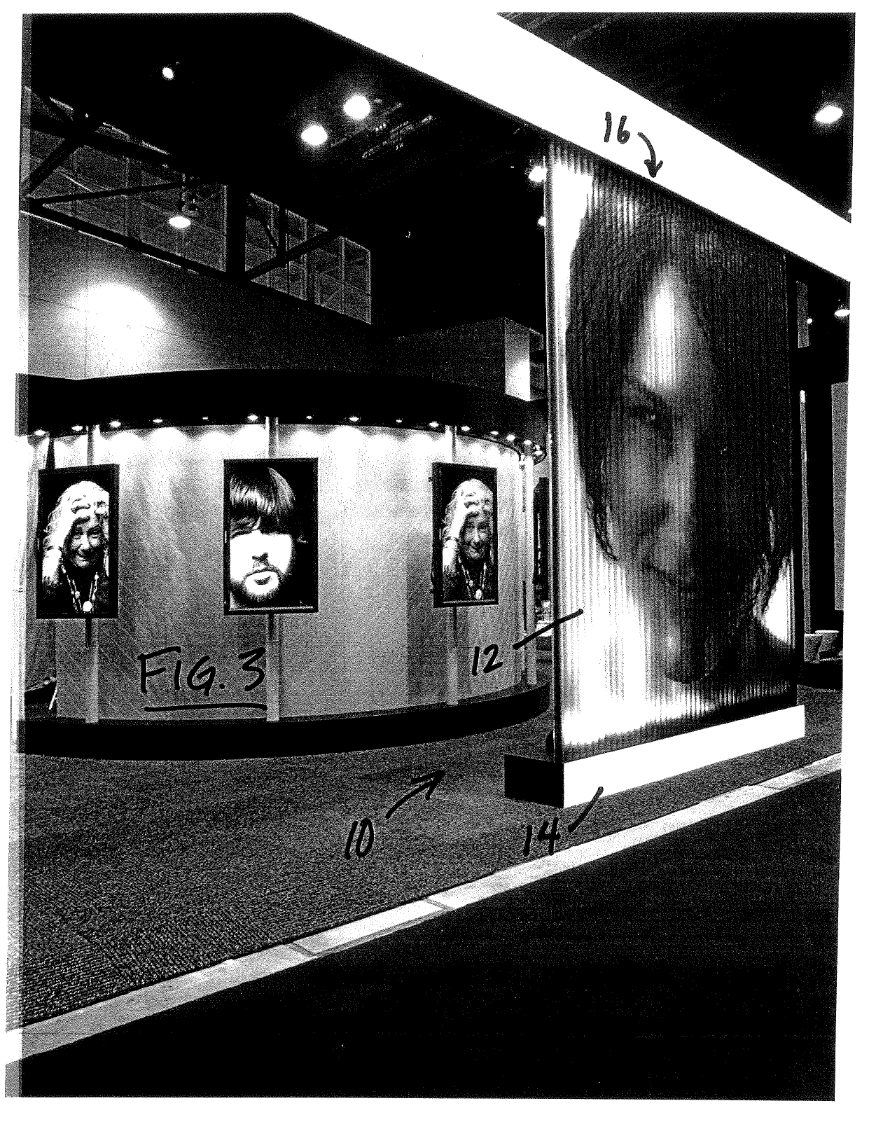

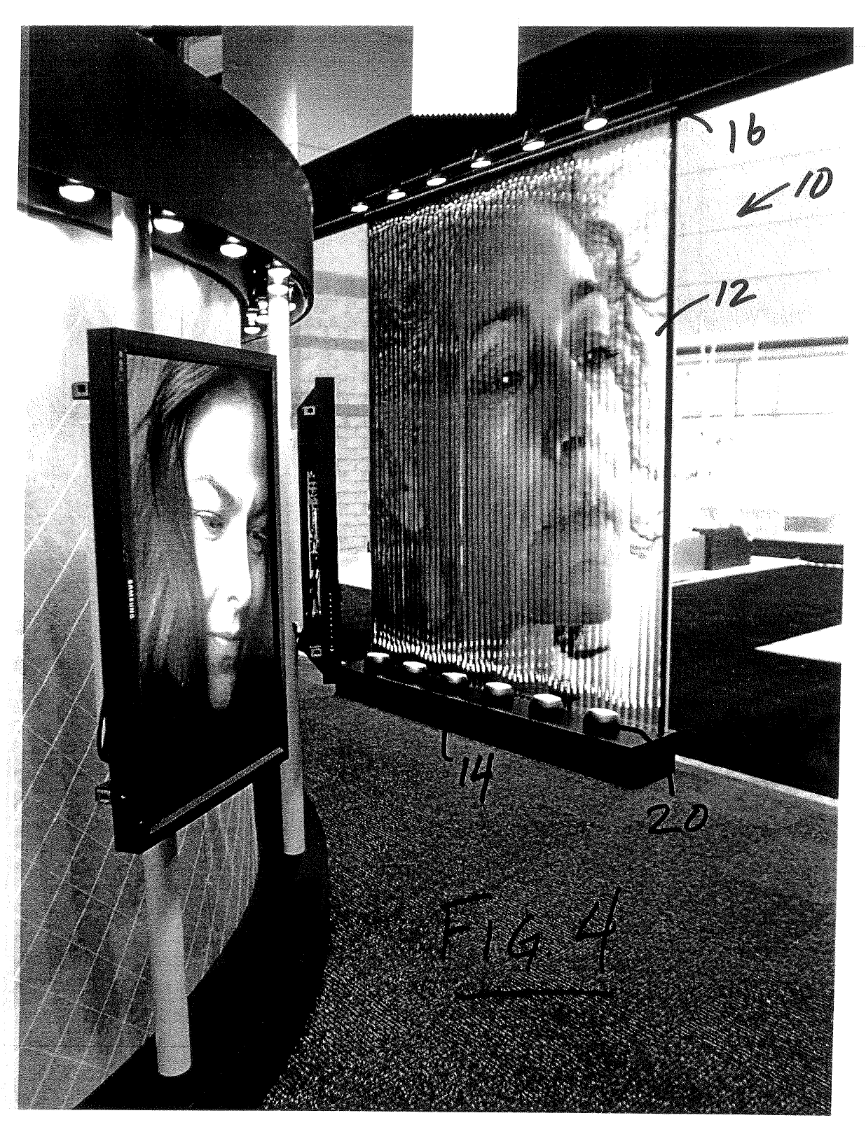

With reference now to the drawing figures, wherein like reference numbers represent corresponding parts throughout the several views, FIGS. 1-4 show an example form of display systems and methods according to the present invention. A system 10 according to the present invention generally comprises an array formed of a plurality of tubes or cylinders 12, optionally supported at the bottom on or in a base or footer 14, and optionally retained at the top by a header or cap 16.

The array can comprise a series of horizontally, vertically, diagonally or otherwise configured tubes or cylinders 12. Preferably the tubes or cylinders 12 of the array are closely spaced or contacting adjacent tubes or cylinders of the array, but alternatively may be separated a distance from adjacent tubes or cylinders.

The tubes or cylinders 12 are preferably transparent, for example formed of clear polyethylene, acrylic, glass, plastic, or other material. Preferably the tubes or cylinders 12 are straight and substantially rigid, but alternatively they can have a degree of flexibility and/or curvature. They can be solid or hollow, and if hollow, optionally may include a fluid or other material within their interior chambers. The length of the tubes can be varied depending upon the application, and tubes of the array can be of the same or differing lengths. Tube diameter may be about one inch, but alternatively can increase or decrease with the intended scale of the application. Alternatively the tubes or cylinders 12 are translucent or opaque. In alternative forms, some of the tubes or cylinders 12 are transparent and some are not. The tubes can be stationary or can be configured for manual or automated movement or repositioning within the base and/or header components.

One or more custom images are applied onto or into some or all of the tubes or cylinders 12 in the display array. In example forms of the invention, the images are printed or otherwise applied onto a flexible transparent or translucent media such as a laminate or film of acrylic, polyethylene, cellophane, plastic, or other material. Preferably, the images are digitally or otherwise altered to be stretched to an approximate ratio of 1/3rd wider than actual width (i.e., approximately a 3:2 expansion of the image in one dimension), and output onto the film laminate material. Alternatively a greater or lesser degree of stretching of the image can be utilized. Physical stretching of the film can alternatively be utilized instead of digital image alteration, or the image can be left unstretched, depending on the desired effect. The images can be color, black-and-white, photographic, digitally created, manually created, and/or other variations or combinations of image format types.

The printed film or other media is cut into thin strips (vertically, horizontally, diagonally or otherwise, depending on the orientation of the elements of the array) and applied to the back exterior of each tube. Alternatively or additionally, the printed images can be applied within the channel of the hollow tubes, and/or on the front and/or side exterior face(s) of the tubes. The film or other media optionally comprises a self-adhesive surface on one face thereof, or alternatively is applied to the tubes using an adhesive or other attachment means.

The clear polyethylene tubes 12 are assembled into a footer 14 so that they sit side by side adjacent to each other. The footers are in modular increments so that they can be sized to whatever wall length you want. For example, multiple footers or base units of differing standard lengths can be combined to form a custom sized display, and as many tubes as needed to span the desired image width (or length) installed into the base units.

The footer 14 and/or header 16 optionally have a built in lighting system 20, comprising one or more light sources, to illuminate the images from the back side, from the front side, from one or both ends, and/or into the interior of the tubular or cylindrical members 12. In example forms, the light sources are incandescent, fluorescent, LED or other form of light source. Alternatively, external light sources transmit light to the display via one or more light conduit(s) such as a fiber-optic light transmission material adjacent or within the tubular or cylindrical members. Tubes can be lit from within or without depending on desired effect. Depending on height a header may be needed which optionally has lighting capabilities from above.

While the invention has been described with reference to preferred and example embodiments, it will be understood by those skilled in the art that a variety of modifications, additions and deletions are within the scope of the invention, as defined by the following claims.

What is claimed is:

1. A graphic display system comprising an array formed of one or more cylindrical members, and having an image displayed therein or thereon.

2. The graphic display system of claim 1, wherein the cylindrical members are hollow tubular members.

3. The graphic display system of claim 1, further comprising a base for retaining the one or more cylindrical members.

4. The graphic display system of claim 1, further comprising a cap for retaining the one or more cylindrical members.

5. The graphic display system of claim 1, wherein the displayed image is applied to a flexible media which is affixed to the one or more cylindrical members.

6. The graphic display system of claim 1, wherein the one or more cylindrical members are transparent.

7. The graphic display system of claim 1, further comprising a lighting system for illuminating at least a portion of the one or more cylindrical members.

8. A method of displaying an image, said method comprising displaying the image on or in an array formed of at least one tubular or cylindrical member.

9. The method of claim 8, wherein the image is displayed by stretching and applying onto the at least one tubular or cylindrical member.
